(19) United States
(12) Patent Application Publication
(10) Pub. No.: US 2026/0336607 A1
(43) Pub. Date: Oct. 29, 2026

(54) VEHICLE AND METHOD FOR CONTROLLING THE SAME

(71) Applicants: HYUNDAI MOTOR COMPANY, Seoul (KR); KIA CORPORATION, Seoul (KR)

(72) Inventors: Dong Hun KANG, Gyeonggi-do (KR); Yim Ju KANG, Gyeonggi-do (KR)

(73) Assignees: HYUNDAI MOTOR COMPANY, Seoul (KR); KIA CORPORATION, Seoul (KR)

(21) Appl. No.: 19/397,161

(22) Filed: Nov. 21, 2025

(30) Foreign Application Priority Data
Apr. 23, 2025 (KR) 10-2025-0052973

(51) Int. Cl. B60W 30/09; B60W 30/16; B60W 30/18; B60W 50/14; G06V 20/58; B60W 60/00

(52) U.S. Cl. CPC B60W 30/09; B60W 30/16; B60W 30/18163; B60W 50/14; G06V 20/584; B60W 60/001; B60W 2420/403; B60W 2554/4041; B60W 2554/4042; B60W 2554/801; B60W 2554/802; B60W 2720/10; G06V 2201/08

(57) ABSTRACT

A control device for an autonomous vehicle may include a memory; and at least one processor operatively connected to the memory. The at least one processor may be configured to obtain, via a sensor unit of the autonomous vehicle, a brake light activation signal of a preceding vehicle and a brake light activation signal of one or more surrounding vehicles, and to control driving of the autonomous vehicle by comparing the brake light activation signal of the preceding vehicle with the brake light activation signal of the one or more surrounding vehicles.

### CROSS-REFERENCE TO RELATED APPLICATION

The present application claims priority to Korean Patent Application No. 10-2025-0052973, filed on Apr. 23, 2025, the present disclosure of which is incorporated herein by reference in its entirety.

### FIELD OF TECHNOLOGY

The present disclosure relates to an autonomous vehicle and a method for controlling an autonomous vehicle.

### BACKGROUND

In autonomous vehicle technology, it is important to promptly recognize and respond to a sudden deceleration or a change in behavior of a preceding vehicle or surrounding vehicles according to an intent thereof.

However, using only conventional camera and radio detection and ranging (RADAR)-based sensors, a delay may occur between an actual behavior of a target vehicle and a point in time of recognition, and in particular, there is a problem in that it is difficult to immediately determine a deceleration intent of the target vehicle.

### BRIEF SUMMARY

An object of the present disclosure is to solve the problems described above by controlling driving of a host vehicle by comparing and analyzing a brake light activation signal of a preceding vehicle and a brake light activation signal of one or more surrounding vehicles.

The objects to be achieved by the present disclosure are not limited to the foregoing objects, and other objects not described herein will be clearly understood by those of ordinary skill in the art from the following description.

A control device for a host vehicle according to various aspects of the present disclosure may include a memory; and at least one processor operatively connected to the memory. The at least one processor may be configured to obtain, via a sensor unit of the host vehicle, a brake light activation signal of a preceding vehicle and a brake light activation signal of one or more surrounding vehicles, and to control driving of the host vehicle by comparing the brake light activation signal of the preceding vehicle with the brake light activation signal of the one or more surrounding vehicles.

In the control device according to various aspects of the present disclosure, the at least one processor may be further configured to compare the brake light activation signal of the preceding vehicle with the brake light activation signal of the one or more surrounding vehicles by compensating for a time delay, wherein the time delay is based on relative positions and inter-vehicle distances among the preceding vehicle, the one or more surrounding vehicles, and the host vehicle.

In the control device according to various aspects of the present disclosure, the at least one processor may be further configured to control the driving of the host vehicle further based on road condition information.

In the control device according to various aspects of the present disclosure, the at least one processor may be further configured to convert brake light activation signals of at least two of the preceding vehicle, the one or more surrounding vehicles, or the host vehicle into binary signals, and to control the driving of the host vehicle by comparing the converted binary signals with each other.

In the control device according to various aspects of the present disclosure, in response to the comparing indicating that a consistency between the brake light activation signal of the preceding vehicle and the brake light activation signal of the one or more surrounding vehicles is less than or equal to a predetermined threshold, the at least one processor may be configured for controlling the driving of the host vehicle to increase a safety distance, which is a distance required for stable deceleration or avoidance of the host vehicle, from the preceding vehicle, or to overtake or avoid the preceding vehicle.

In the control device according to various aspects of the present disclosure, in response to the brake light activation signal of the preceding vehicle changing by an amount greater than or equal to a reference threshold, the at least one processor may be configured for controlling the driving of the host vehicle to decelerate the host vehicle, increase an inter-vehicle distance of the host vehicle with the preceding vehicle, or avoid the preceding vehicle.

In the control device according to various aspects of the present disclosure, the at least one processor may be further configured to compare the brake light activation signal of the preceding vehicle and the brake light activation signal of the one or more surrounding vehicles with a brake light activation signal of the host vehicle to determine a driving pattern of the host vehicle, and to provide a result of the determining to a user via an input/output interface of the host vehicle.

In the control device according to various aspects of the present disclosure, brake lights of the preceding vehicle and the one or more surrounding vehicles, from which the brake light activation signals are obtained, may include at least one of a first brake lamp on a rear side of the respective vehicle, or a second brake lamp located at a different location on the rear side of the respective vehicle.

In the control device according to various aspects of the present disclosure, the at least one processor may be further configured to determine whether to follow the preceding vehicle based on the comparing of the brake light activation signal of the preceding vehicle and the brake light activation signal of the one or more surrounding vehicles, and to control the driving of the host vehicle to follow or not to follow the preceding vehicle based on a result of the determining.

In the control device according to various aspects of the present disclosure, the at least one processor may be configured to control the driving of the host vehicle by comparing the brake light activation signal of the preceding vehicle and the brake light activation signal of the one or more surrounding vehicles, based on that an image recognition accuracy obtained via the sensor unit or an object recognition reliability of the sensor unit is less than or equal to a predetermined threshold.

A method for controlling a host vehicle according to various aspects of the present disclosure may include: obtaining, via a sensor unit of the host vehicle, a brake light activation signal of a preceding vehicle and a brake light activation signal of one or more surrounding vehicles; comparing the brake light activation signal of the preceding vehicle with the brake light activation signal of the one or more surrounding vehicles; and controlling the driving of the host vehicle based on a result of the comparing.

In the method according to various aspects of the present disclosure, the comparing may include compensating for a time delay based on relative positions and inter-vehicle distances among the preceding vehicle, the one or more surrounding vehicles, and the host vehicle.

In the method according to various aspects of the present disclosure, the controlling the driving of the host vehicle may be further based on road condition information.

The method according to various aspects of the present disclosure may further include: converting brake light activation signals of at least two of the preceding vehicle, the one or more surrounding vehicles, or the host vehicle into binary signals, wherein the comparing includes mutually comparing the converted binary signals.

In the method according to various aspects of the present disclosure, the controlling may comprise, in response to the comparing indicating that a consistency between the brake light activation signal of the preceding vehicle and the brake light activation signal of the one or more surrounding vehicles is less than or equal to a predetermined threshold: increasing a safety distance, which is a distance required for stable deceleration or avoidance of the host vehicle, from the preceding vehicle, or overtaking or avoiding the preceding vehicle.

In the method according to various aspects of the present disclosure, the controlling may comprise, in response to the brake light activation signal of the preceding vehicle changing by an amount greater than or equal to a reference threshold: decelerating the host vehicle, increasing an inter-vehicle distance of the host vehicle with the preceding vehicle, or avoiding the preceding vehicle.

The method according to various aspects of the present disclosure may further include: comparing the brake light activation signal of the preceding vehicle and the brake light activation signal of the one or more surrounding vehicles with a brake light activation signal of the host vehicle to determine a driving pattern of the host vehicle; and providing a result of the determining to a user via an input/output interface of the host vehicle.

In the method according to various aspects of the present disclosure, the brake light activation signals may be obtained from brake lights of the preceding vehicle and the one or more surrounding vehicles, wherein the brake lights include at least one of a first brake lamp on a rear side of the respective vehicle, or a second brake lamp located at a different location on the rear side of the respective vehicle.

The method according to various aspects of the present disclosure may further include: determining whether to follow the preceding vehicle based on the comparison; and controlling the driving of the host vehicle to follow or not to follow the preceding vehicle based on a result of the determining.

In the method according to various aspects of the present disclosure, the comparing and the controlling may be performed based on that an image recognition accuracy obtained via the sensor unit or an object recognition reliability of the sensor unit is less than or equal to a predetermined threshold.

According to an exemplary embodiment of the present disclosure, by obtaining and mutually comparing and analyzing brake light activation signals of a preceding vehicle and surrounding vehicles, a host vehicle may promptly recognize an unexpected or abnormal deceleration situation of the preceding vehicle.

Furthermore, even when sensor recognition accuracy is low in adverse weather or low-light environments, stable autonomous driving performance may be maintained by effectively determining a traffic flow based on the brake light activation signals.

The effects of the present disclosure are not limited to the effects mentioned above, and other effects not described herein will be clearly understood by those of ordinary skill in the art from the following description.

### BRIEF DESCRIPTION OF THE DRAWINGS

FIG. 1 is a block diagram of an autonomous vehicle according to an exemplary embodiment of the present disclosure.

FIG. 2 is a flowchart illustrating a method for controlling an autonomous vehicle based on a brake light signal according to an exemplary embodiment of the present disclosure.

FIG. 3 is a flowchart illustrating a method for detailed comparative analysis of a brake light signal and driving control according to an exemplary embodiment of the present disclosure.

FIG. 4 is an exemplary view exemplarily illustrating brake lights on a rear side of a vehicle according to an exemplary embodiment of the present disclosure.

FIG. 5 is an exemplary view exemplarily illustrating a relative positional relationship among an autonomous vehicle, a preceding vehicle, and surrounding vehicles according to an exemplary embodiment of the present disclosure.

FIG. 7 is an exemplary view exemplarily illustrating a method for time delay compensation and binary signal conversion comparison of a brake light activation signal according to an exemplary embodiment of the present disclosure.

### DETAILED DESCRIPTION

Hereinafter, one or more example embodiments of the present disclosure will be described in detail with reference to the accompanying drawings.

However, the technical idea of the present disclosure is not limited to the example embodiments as described herein but may be implemented in various different forms, and within the scope of the technical idea of the present disclosure, one or more among components in the example embodiments may be used by being selectively combined and substituted.

Furthermore, unless defined and described, terms used in the example embodiments of the present disclosure (including technical and scientific terms) may be interpreted as meanings which are generally understood by those skilled in the art to which the present disclosure pertains, and commonly used terms such as terms defined in the dictionary may be interpreted based on the contextual meaning of the related art.

The terms used in the example embodiments of the present disclosure are for the purpose of describing the example embodiments only and are not intended to limit the present disclosure.

In the present specification, the singular forms may include the plural forms unless the context clearly dictates otherwise. For purposes of The present application and the claims, using the exemplary phrase “at least one of: A; B; or C” or “at least one of A, B, or C,” the phrase means “at least one A, or at least one B, or at least one C, or any combination of at least one A, at least one B, and at least one C. Furthermore, exemplary phrases, such as "A, B, or C", "at least one of A, B, and C", "at least one of A, B, or C", etc. as used herein may mean each listed item or all possible combinations of the listed items. For example, "at least one of A or B" may refer to (1) at least one A; (2) at least one B; or (3) at least one A and at least one B.

Furthermore, in describing a component of example embodiments of the present disclosure, terms such as first, second, A, B, (a), (b), etc., may be used.

These terms are only for distinguishing the component from other components, and the essence, sequence, or order of the component is not limited by the terms.

Furthermore, when a component is described as being “linked,” “coupled,” or “connected” to another component, the component is not only directly linked, coupled, or connected to another component, but also “linked,” “coupled,” or “connected” to another component with yet another component disposed between the component and the other component.

Furthermore, when a component is described as being formed or disposed “on (above) or under (below)” of another component, the term “on (above) or under (below)” includes not only when two components are in direct contact with each other, but also when one or more of other components are formed or disposed between the two components. Furthermore, when a component is described as being “on (above) or below (under),” the description may include the meanings of an upward direction and a downward direction based on one component.

In the various flowcharts of the present disclosure, at least some of the steps may be omitted or the mutual order thereof may be changed, and at least some of the various embodiments of the present specification may be performed at a specific point in time of each step of the flowcharts. The operations of the various flowcharts of the present specification may be performed by at least one of the control device 100, the processor 130, or the autonomous vehicle 10. Furthermore, redundant content in the drawings of the present specification may be omitted. In the present specification, ‘the control device 100’ may also be referred to as ‘the autonomous vehicle control device 100’.

The term "autonomous driving system" or "driver control assistance system" as used in the present specification refers to hardware and software configured for assisting the driver in continuously controlling the longitudinal and lateral movements of the vehicle. The present driver control assistance system may be referred to as the “system” in the present specification.

The term "feature" as used in the present specification may refer to a specific function of the system that provides assistance to the driver under defined traffic scenarios, conditions, and system boundaries.

The term "dynamic control" as used in the present specification may refer to the real-time performance of operational and tactical functions required to move the vehicle. This may include control of the vehicle’s lateral and longitudinal movements, monitoring of the road environment, response to events in the road traffic environment, operational planning, and signal delivery.

The term "system boundaries" as used in the present specification may refer to verifiable or measurable limits or conditions set by the manufacturer, up to or within the range of the conditions that affect the ability of the system or its features to operate as intended and to provide assistance to the driver.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

Based on one or more features (e.g., evaluating the engagement state of the driver) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., evaluating the engagement state of the driver) described herein. One or more communication devices (e.g., a modem, a network adapter, a radio transceiver, an antenna, etc., that is capable of communicating via or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., evaluating the engagement state of the driver) described herein.

Minimum risk maneuver (MRM) operation(s) may also be controlled, for example, based on one or more features (e.g., evaluating the engagement state of the driver) described herein. A minimal risk maneuvering operation (e.g., a minimal risk maneuver, a minimum risk maneuver) may be a maneuvering operation of a vehicle to minimize (e.g., reduce) a risk of collision with surrounding vehicles to reach a lowered (e.g., minimum) risk state. A minimal risk maneuver may be an operation that may be activated during autonomous driving of the vehicle when a driver is unable to respond to a request to intervene. During the minimal risk maneuver, at least one processor of the vehicle may be configured for controlling a driving operation of the vehicle for a predetermined time period.

Biased driving operation(s) may also be controlled, for example, based on one or more features (e.g., evaluating the engagement state of the driver) described herein. A driving control apparatus may perform a biased driving control. To perform a biased driving, the driving control apparatus may be configured for controlling the vehicle to drive in a lane by maintaining a lateral distance between the position of the center portion of the vehicle and the center portion of the lane. For example, the driving control apparatus may be configured for controlling the vehicle to stay in the lane but not in the center portion of the lane.

The driving control apparatus may identify a biased target lateral distance for biased driving control. For example, a biased target lateral distance may include an intentionally adjusted lateral distance that a vehicle may aim to maintain from a reference point, such as the center portion of a lane or another vehicle, during maneuvers such as lane changes. The present adjustment may be made to improve the vehicle's stability, safety, and/or performance under varying driving conditions, etc. For example, during a lane change, the driving control system may bias the lateral distance to keep a safer gap from neighboring vehicles, considering factors such as the vehicle's speed, road conditions, and/or the presence of obstacles, etc.

One or more sensors (e.g., IMU sensors, camera, LiDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., evaluating the engagement state of the driver) described herein.

An operation control for autonomous driving (e.g., controlling an autonomous driving function) of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, driver warning control, autonomous driving operational design domain (ODD) control, etc.).

An autonomous driving level and/or autonomous driving activation/deactivation may also be controlled, for example, based on one or more features (e.g., evaluating the engagement state of the driver) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his or her hands on the driving wheel more often (e.g., at least once in a threshold time period, such as five second, 30 seconds, 1 minute, etc.). by changing the required user attentiveness, the driver may be required to look ahead more often (e.g., at least once in a threshold time period, such as five second, 30 seconds, 1 minute, etc.). By changing the autonomous driving level, one or more video contents may not be displayed on a display of the vehicle.

In the various flowcharts of the present disclosure, one or more operations may be omitted or performed in any other order. At least some of the example embodiments of the present disclosure may be performed at any particular or arbitrary point in each operation of the flowchart. Various flowcharts of the present disclosure may be performed by at least one of an autonomous driving control device (also referred to as a driving automation device or driving automation system), a processor 130, a control unit 100, an autonomous vehicle 10, or a computer program.

Hereinafter, one or more example embodiments will be described in detail with reference to the accompanying drawings, but identical or corresponding components are denoted by the same reference numerals regardless of figure numbers, and redundant descriptions thereof will be omitted.

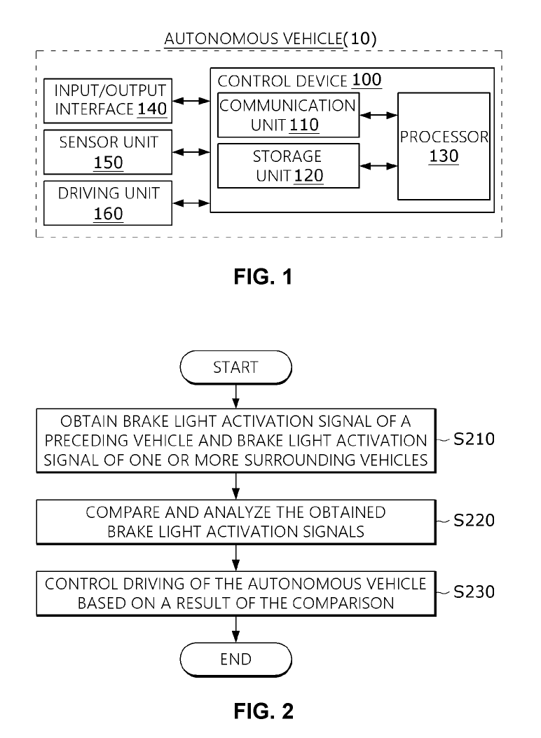

FIG. 1 is a block diagram of an autonomous vehicle 10 according to an exemplary embodiment of the present disclosure.

The autonomous vehicle 10 may include a control device 100, a communication unit 110, a storage unit 120, a processor 130, an input/output interface 140, a sensor unit 150, and a driving unit 160. Each of these components of FIG. 1 may be implemented inside the vehicle.

The autonomous vehicle 10 may be dynamically controlled in various driving situations through an autonomous driving system. For example, the autonomous driving system may provide both driving stability and convenience through longitudinal control (acceleration and deceleration) and lateral control (lane keeping and changing) of the autonomous vehicle 10. Such an autonomous driving system may monitor the driving environment through sensors and a control device, and process data in real time to adjust the position, driving speed, direction, and the like of the vehicle.

The control device 100 may be integrally formed with other internal components of the vehicle. Alternatively, the control device 100 may be implemented as a separate device and may communicate with the internal components of the vehicle via various connection devices (e.g., a Controller Area Network (CAN) bus, a wireless network, a wired connection, etc.). The control device 100 includes the communication unit 110, the storage unit 120, and the processor 130 to manage the longitudinal and lateral control of the vehicle, and may additionally include other components such as the input/output interface 140, the sensor unit 150, and the driving unit 160 to perform complex control functions according to a driving situation.

According to an exemplary embodiment of the present disclosure, the control device 100 may receive, from the sensor unit 150, sensor information (e.g., first data) including a distance and a speed of a surrounding object. Furthermore, the control device 100 may receive, via the communication unit 110, road event information based on navigation information (e.g., second data). The control device 100 may be configured to determine a target speed of the autonomous vehicle 10 based on the first data and the second data using the processor 130. The processor 130 may be configured for controlling driving of the autonomous vehicle 10 in accordance with the determined target speed.

The control device 100 may store data collected from the sensor unit 150 while driving in the storage unit 120, and process the data in real time to control safety and convenience functions of the vehicle. For example, the control device 100 may perform overall control and management of the autonomous driving system, such as providing a notification in a situation in which driver intervention is required, based on data detected from the sensor unit 150.

The control device 100 may, based on various driver settings and driving conditions, display a vehicle control status or control a driving function by receiving a driver's input, through a user interface linked with a Human-Machine Interface (HMI).

According to an exemplary embodiment of the present disclosure, the control device 100 may, via the processor 130, control driving of the vehicle more safely and efficiently by comparing brake light activation signals of a preceding vehicle and surrounding vehicles.

The communication unit 110 may share data between systems by communicating with other control devices inside the vehicle, or may transmit and receive various information through a connection with an exterior of the vehicle. The communication unit 110 transmits control signals and data between internal components using various in-vehicle communication methods such as Controller Area Network (CAN) communication and Ethernet, and may link driving information and external data in real time through communication with a user terminal, other vehicles (Vehicle-to-Vehicle (V2V), infrastructure (V2I: Vehicle-to-Infrastructure), or an external server.

The communication unit 110 may perform short-range communication, Vehicle-to-Everything (V2X) communication, optical communication, broadcast transmission and reception, and Intelligent Transport Systems (ITS) communication functions, and may include a Global Navigation Satellite System (GNSS) module (e.g., a Global Positioning System (GPS) module). For example, the communication unit 110 may support stable data transmission at a short range using various wireless communication technologies such as Bluetooth®, Radio Frequency Identification (RFID), Infrared Data Association (IrDA), Ultra Wideband (UWB), ZigBee, Near Field Communication (NFC), Wi-Fi, Wi-Fi Direct, and Wireless USB. Furthermore, the communication unit 110 may perform long-range communication via a mobile communication module (e.g., based on Long-Term Evolution (LTE) and 5G networks) and a wireless Internet module, and may improve the performance of the autonomous driving system by receiving real-time data or interworking with a cloud.

The storage unit 120 may include various types of memory configured for storing data, and may be integrated into the control device 100 or the processor 130, or may be configured in the form of a separate module. The storage unit 120 may include non-volatile memory and volatile memory, and may implement a memory system of various capacities and performances by combining them.

According to an exemplary embodiment of the present disclosure, the storage unit 120 may include a memory configured for storing and managing various data related to the autonomous driving system.

The processor 130 communicates with various internal components of the autonomous vehicle 10, such as the communication unit 110, the storage unit 120, the input/output interface 140, the sensor unit 150, and the driving unit 160, through an electrical or operative connection, and may be configured for controlling the operation of each component and perform data processing. The processor 130, as a central processing unit of executing instructions and determining data, may perform vehicle control by collecting, processing, and analyzing data in real time according to the driving environment of the vehicle.

The processor 130 may be implemented in a form of hardware, software, or a combination thereof, and may, for example, perform vehicle control logic in a form of a microcontroller, an FPGA, or an ASIC. Furthermore, it may also include a multi-processor configuration for controlling complex autonomous driving and driver assistance systems. Such a processor configuration may support comprehensive control and stable performance of the vehicle through functions such as execution of autonomous driving and assistance systems, sensor data processing, communication data management, and driving-related determination functions.

According to an exemplary embodiment of the present disclosure, the processor 130 may compare brake light activation signals of a preceding vehicle and surrounding vehicles obtained by the sensor unit 150 to determine an unexpected situation or an abnormal driving state of the preceding vehicle, and may be configured for controlling the autonomous vehicle 10.

When a sensor recognition accuracy is less than or equal to a predetermined threshold in an environment where sensor reliability is low, such as a low-light environment or adverse weather, the processor 130 may be configured for controlling driving of the autonomous vehicle 10 based on brake light activation signals according to an exemplary embodiment of the present disclosure.

The input/output interface 140 is configured to receive an input related to vehicle control from a user and transmit vehicle control status and system operation information to the user.

The input/output interface 140 may perform a function of receiving various inputs from a user and transmitting a vehicle control status to the user. For example, the input/output interface 140 may include at least one of: an input through a physical button disposed inside the autonomous vehicle 10, an input through a soft button displayed on a display of the autonomous vehicle 10, a user's voice input, and a user's gesture input.

According to an exemplary embodiment of the present disclosure, the input/output interface 140 may provide a result of a driving pattern determination for the vehicle, as determined by the processor 130, to a user visually, audibly, or tactilely to guide an improvement in driving habits.

The input module may include a physical button, a soft key on a touch display, a voice recognition function, a gesture recognition function, and the like, through which a user may input commands such as an autonomous driving system activation request, a function switch, or a driving assistance setting.

Furthermore, the input module may receive a user input through an input device disposed on a steering wheel of the autonomous vehicle 10. For example, through a button disposed on the steering wheel, a driver may input a command to activate or deactivate the autonomous driving system even while driving. Such a steering wheel-based input may support a user to promptly control the autonomous driving function by providing an intuitive interface.

The output module includes a display, an audio module (e.g., a speaker), a haptic module, and the like, and may provide, to a user, a status of the autonomous driving system, a control switch request notification, and information on whether a function is activated, in visual, auditory, and tactile forms.

Furthermore, a user may intuitively check the status of the autonomous driving system through a head-up display (HUD), a cluster, an Audio Video Navigation (AVN) system, and a display embedded in a rear-view mirror or a side mirror. Besides, the status of the autonomous driving system may be checked through a display of a console disposed in each row of the autonomous vehicle 10, an application of a user terminal, and the like.

The sensor unit 150 may include a plurality of sensors that detect various driving and environmental information in real time to support stable operation of the autonomous driving system. The sensor unit 150 may measure a distance to and a speed of a surrounding object through long-range detection sensors such as a Radio Detection and Ranging (RADAR) sensor and a Light Detection and Ranging (LIDAR) sensor, and may include an ultrasonic sensor to detect an object near to the autonomous vehicle 10.

Furthermore, the sensor unit 150 may include a position sensor, such as a GPS, to collect position information of the autonomous vehicle 10, and an optical sensor to provide surrounding illumination information, thereby allowing the system to respond to changes in light. Furthermore, the sensor unit 150 may monitor a driving control state and a user's action of the autonomous vehicle 10 by including sensors such as an accelerator pedal and deceleration pedal sensor, a steering wheel detection sensor, and a seating sensor.

The sensor unit 150 may include a camera. The camera may be classified into an external camera and an internal camera. The external camera recognizes the road and the surrounding environment, and the internal camera may comprehensively grasp the situation inside and outside the vehicle by detecting a driver's state (e.g., eye tracking, drowsiness detection) or an indoor situation.

The sensor unit 150 may collect a driver's biometric information or various environmental data by including a heart rate sensor, a pressure sensor, an infrared sensor, and the like.

The driving unit 160 may include various components that provide a driving force necessary for driving of the autonomous vehicle 10 and control an operation of the vehicle according to a command output from the control device 100. The driving unit 160 may include devices that generate and transmit power of the vehicle, such as an engine, a motor, a transmission, and a wheel drive system, and a controller that is configured to control them, and through these components, acceleration, deceleration, and a direction change of the autonomous vehicle 10 may be performed.

The driving unit 160 may be controlled to perform longitudinal control (acceleration and deceleration) and lateral control (lane keeping and changing) to maintain driving stability. For example, upon receiving a command from the control device 100, the driving unit 160 allows the vehicle to follow a driving path by adjusting an output of a motor or a rotation speed and direction of wheels.

Furthermore, the driving unit 160 may include a brake system to reduce the vehicle speed or stop the vehicle while driving. The driving unit 160 may be configured for controlling the autonomous vehicle 10 through an electric motor in the case of an electric vehicle, and based on engine output in the case of an internal combustion engine vehicle.

According to an exemplary embodiment of the present disclosure, after determining a suitability for following a preceding vehicle, the processor 130 may continue or terminate the vehicle following, and may be configured for controlling the driving unit 160 to overtake or avoid the preceding vehicle.

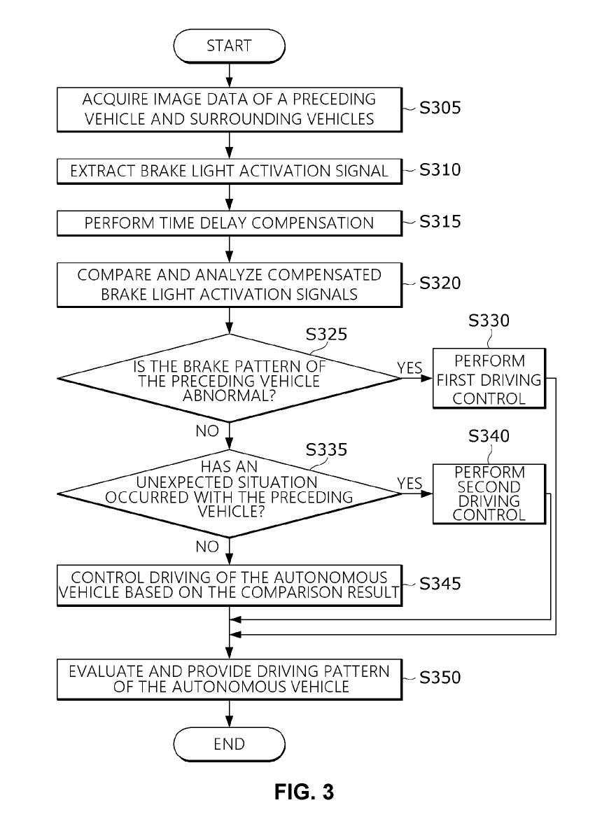

FIG. 2 is a flowchart illustrating a control method of an autonomous vehicle based on brake light activation signals according to an exemplary embodiment of the present disclosure

The processor 130 may obtain brake light activation signals of a preceding vehicle and one or more surrounding vehicles excluding the preceding vehicle via a sensor unit 150 (S210).

For example, the sensor unit 150 may, via a front camera of the autonomous vehicle 10, obtain a change in brightness of a brake light located on a rear side of a vehicle as an image. The processor 130 may obtain whether brake lamps (rear brake lights disposed on left and right sides) or a brake light located in at least one region of the rear side of the vehicle (e.g., a Center High Mounted Stop Lamp (CHMSL)) are activated, as respective signals or as one or more signals. The processor 130 may be configured to determine a case in which a signal change greater than or equal to a predetermined brightness (luminance) reference value occurs in a pixel area of a vehicle brake light within an image captured by the camera as a brake light activation signal, and obtain the signal.

In a process of obtaining the brake light activation signal, the processor 130 may be configured for processing the signal as time-series data, and such data may be used in a signal comparison and analysis process to be described later.

In the instant case, the processor 130 may obtain whether a first brake lamp (e.g., rear brake lights disposed on left and right sides) or a second brake lamp located at a different location on the rear side of the vehicle (e.g., a Center High Mounted Stop Lamp (CHMSL)) are activated

The processor 130 may compare and analyze the obtained brake light activation signal of the preceding vehicle and brake light activation signals of the surrounding vehicles (S220).

For example, to perform the comparison and analysis of the brake light activation signals, the processor 130 may define each signal as an activation pattern during a specific time interval.

The processor 130 may convert the signals into a binary form to generate time-series data in which a point in time of brake light activation is represented as '1' and a point in time of deactivation is represented as '0'. The processor 130 may, based on such data in a binary signal form, quantitatively evaluate whether the signal of the preceding vehicle is similar to the signals of the surrounding vehicles or has a peculiarity.

In the comparison and analysis process, the processor 130 may compensate for a time delay based on a relative position and an inter-vehicle distance between vehicles, and a detailed operation related thereto will be described later.

The processor 130 may be configured for controlling driving of the autonomous vehicle 10 based on a result of the comparing and analysis of the brake light activation signals (S230).

In detail, the processor 130 may be configured for controlling driving of the autonomous vehicle 10 based on the result of the comparison and analysis. For example, when a braking pattern of the preceding vehicle is abnormal as compared to surrounding vehicles (e.g., a similarity of less than 70%), the processor 130 may reduce a speed of the autonomous vehicle 10 or increase a safety distance from the preceding vehicle.

Safety distance may refer to an inter-vehicle distance or a time-based criterion that is required to be secured while driving control so that the autonomous vehicle can perform stable braking or avoidance maneuvers without interference from a preceding vehicle.

The safety distance may be preset, or may be dynamically configured by considering a current speed of the autonomous vehicle, a degree of deceleration of the preceding vehicle, road conditions, an inter-vehicle distance, a driving pattern of surrounding vehicles, and the like.

For example, when a consistency between signals is determined to be less than or equal to a predetermined threshold based on a result of the comparing between the brake light activation signal of the preceding vehicle and the brake light activation signal of the one or more surrounding vehicles, the control device may be configured to determine that the driving of the preceding vehicle is abnormal or that an unexpected situation is likely to have occurred, and may configure the safety distance to be secured by the autonomous vehicle to be greater than the existing inter vehicle distance.

Furthermore, when an unexpected situation occurs, the processor 130 may be configured for controlling the driving unit 160 of the vehicle to perform an emergency deceleration, avoidance, a lane change, or the like.

When the brake light activation signal of the preceding vehicle has low consistency as compared to the brake light activation signals of surrounding vehicles, or exhibits an abnormal pattern (e.g., a pattern in which sudden stops and sudden accelerations are repeated, or a pattern in which a braking frequency is remarkably high), the processor 130 may be configured to determine the corresponding preceding vehicle to be a risk factor.

According to an exemplary embodiment of the present disclosure, when it is determined that a braking pattern of the preceding vehicle is abnormal or unexpected as compared to patterns of surrounding vehicles, the processor 130 may adjust driving of the vehicle in real time by transmitting a driving control command such as deceleration, overtaking, or a lane change to the driving unit 160 of the autonomous vehicle 10. In the instant case, the processor 130 may indirectly determine an unexpected situation on a road (e.g., an obstacle, a sudden stop, etc.) from a result of the pattern comparison of the preceding vehicle and the surrounding vehicles, and accordingly, may perform longitudinal control (a speed change) and lateral control (a lane change and overtaking) of the vehicle. Herein, the threshold may be defined based on a result of comparing factors such as a similarity, a frequency, or a duration of the brake light activation signals, and the safety distance may be expressed as a physical distance (e.g., in meters) or a time interval (e.g., in seconds).

Additionally, the processor 130 may maintain or increase the safety distance from the preceding vehicle by continuously considering a relative position and speed between vehicles.

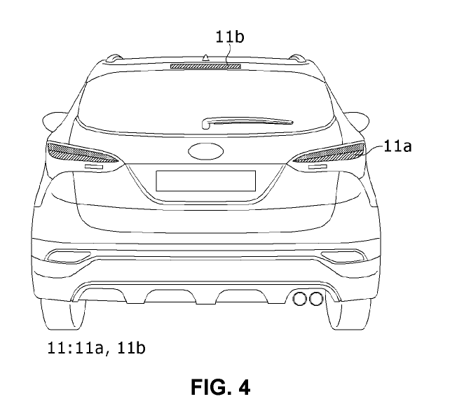

Such a detailed determination and control process will be described in detail with reference to FIG. 3.

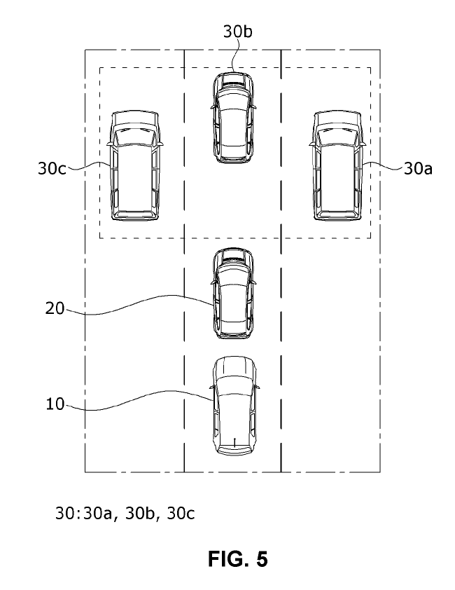

FIG. 3 is a flowchart illustrating a method for detailed comparative analysis of a brake light signal and driving control according to an exemplary embodiment of the present disclosure. The description of FIG. 3 will be provided with reference to FIGS. 4, 5, 6, and 7.

The processor 130 may obtain image data by capturing images of a preceding vehicle and surrounding vehicles via the sensor unit 150 of the autonomous vehicle 10 (S305).

In detail, the processor 130 may obtain image data by capturing images of a preceding vehicle and one or more surrounding vehicles via the sensor unit 150 of the autonomous vehicle 10. For example, the processor 130 may, using a front camera of the vehicle, capture in real time an image including a road environment and brake lamps and a Center High Mounted Stop Lamp (CHMSL) on a rear side of the preceding vehicle and one or more surrounding vehicles.

For example, referring to FIG. 4, a state is illustrated in which a first brake lamp 11a, which may be disposed on the left and right sides of a rear side of preceding vehicle and one or more surrounding vehicles, and a second brake lamp 11b, which may be a Center High Mounted Stop Lamp (CHMSL) disposed at a different location such as the upper center portion of the rear side of the preceding vehicle and one or more surrounding vehicles, are activated.

According to an exemplary embodiment of the present disclosure, the processor 130 may, via a front camera of the vehicle disposed in the sensor unit 150, extract from image data whether the brake lights 11 as described above, captured as shown in FIG. 4, are activated and an activation signal pattern thereof, and may utilize the same for driving control of the vehicle.

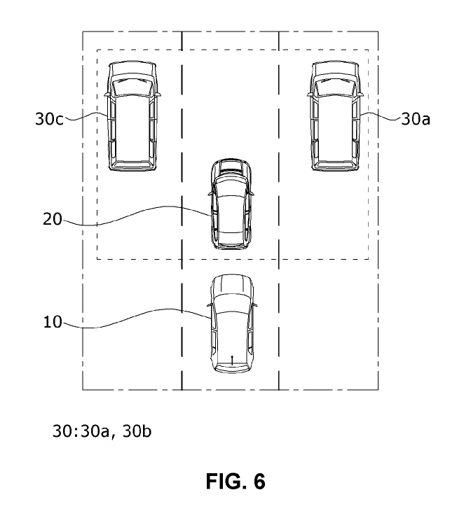

Furthermore, referring to FIG. 5, a vehicle located in a front lane with respect to the autonomous vehicle 10 is a preceding vehicle 20, and vehicles 30a, 30b, and 30c located in surrounding lanes, other than the preceding vehicle 20, may be defined as surrounding vehicles 30. According to an exemplary embodiment of the present disclosure, the processor 130 may compare with each other the brake light activation signal of the preceding vehicle 20 and the brake light activation signal of the surrounding vehicles 30, obtained via the sensor unit 150, to determine whether a braking pattern of the preceding vehicle 20 is normal or abnormal as compared to a braking pattern of the surrounding vehicles 30.

The processor 130 may extract, from the image data, a brake light activation signal including brake lamps and a Center High Mounted Stop Lamp (CHMSL) on a rear side of a vehicle (S310).

The processor 130 may extract the brake light activation signal by analyzing, from the obtained image data, whether the brake lamps and the Center High Mounted Stop Lamp (CHMSL) on a rear side of a vehicle are activated.

The processor 130 may, using an image processing algorithm, detect a change in pixel brightness in a predetermined area on a rear side of a vehicle (a position of a brake lamp and a CHMSL). For example, when an average brightness of the corresponding area is greater than or equal to a predetermined value (e.g., 150 lux), the processor 130 may be configured to determine that the brake light is activated, and may convert the present information into a binary signal (activation: 1, deactivation: 0) and store the binary signal as time-series data.

In a manner as described above, the processor 130 may identify a predetermined area on a rear side of a vehicle in the image data (e.g., lower left and right brake lamp areas and an upper center CHMSL area of the vehicle). When not only a pixel luminance but also a contrast of such an area exceeds a predetermined reference value (Threshold), the processor 130 may be configured to determine that a brake light is activated, and when the value is less than the reference value, the processor 130 may be configured to determine a deactivated state and extract a signal.

Furthermore, the processor 130 may convert the extracted signal into a digital binary form, and may store the converted data in the storage unit 120.

In detail, the processor 130 may define an activated state of a brake light as '1' and a deactivated state as '0', and may be configured to generate binary time-series data in which brake light activation signals obtained at regular time intervals are arranged in chronological order. The generated binary time-series data may be used in a subsequent comparison and analysis process to quantitatively evaluate a similarity or a difference between braking patterns of the preceding vehicle, the surrounding vehicles, and the autonomous vehicle 10.

The processor 130 may be configured to determine and compensate for a time delay based on a relative position and an inter-vehicle distance among the preceding vehicle, the surrounding vehicles, and the autonomous vehicle 10 (S315).

In detail, to reduce an error between a point in time at which a braking signal of each vehicle actually occurs and a point in time at which the signal reaches the sensor unit 150 and is recognized, the processor 130 may compensate for the time delay by considering factors such as a relative distance between vehicles, a relative speed, and a sensor processing time.

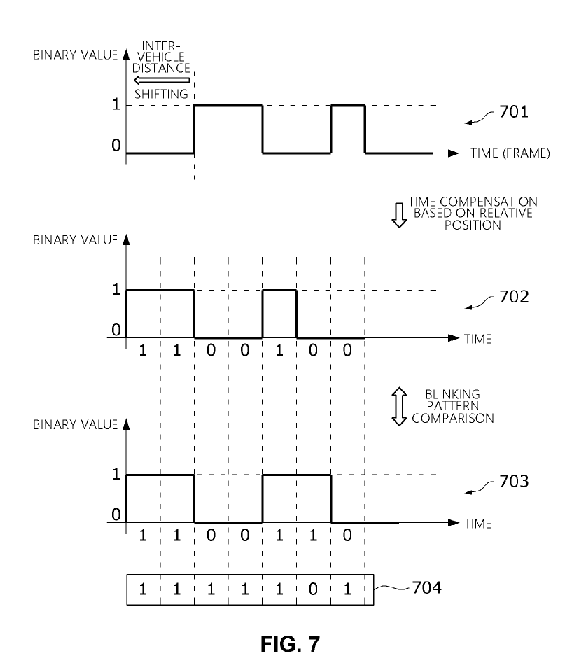

For example, referring to FIG. 7, blinking patterns 701 and 702 represent a brake light blinking pattern of a preceding vehicle or a surrounding vehicle. These blinking patterns represent a point in time (signal: 1) when the preceding vehicle or the surrounding vehicle brakes and a brake light is activated, and a point in time (signal: 0) when the brake light is not activated.

In the instant case, due to an inter-vehicle distance existing between a preceding vehicle and the autonomous vehicle, the sensor unit 150 of the autonomous vehicle may obtain an activation signal at a point in time that is delayed from a point in time at which the preceding vehicle actually activated the brake light. The processor 130 may compensate for (shift) the present time delay, thereby compensating for the existing blinking pattern 701 to be like the blinking pattern 702. Through this, the processor 130 may compensate for and represent the brake light activation signal of the preceding vehicle or the surrounding vehicle to match an actual time of occurrence.

Furthermore, the processor 130 may compare with each other the compensated brake light activation signal of the preceding vehicle or the surrounding vehicle (the blinking pattern of 702) and the brake light activation signal of the autonomous vehicle 10 (the blinking pattern of 703), to perform an evaluation of a driving pattern or a determination for driving control of the autonomous vehicle.

For example, in the blinking pattern 702 of FIG. 7, an absolute amount of brake light activation of the preceding vehicle or the surrounding vehicle is 3 (=1+1+0+0+1+0+0), which is a value obtained by summing the number of occurrences of the value '1', and in the blinking pattern 703, the absolute amount of brake light activation of the autonomous vehicle 10 may be represented as 4 (=1+1+0+0+1+1+0).

The processor 130 may perform a comparison and analysis based on the brake light activation signal compensated for in step S315 (S320).

The processor 130 may be configured to determine a similarity using the brake light activation pattern converted into a binary signal, and may evaluate how much the braking pattern of the preceding vehicle matches an average braking pattern of the surrounding vehicles.

The processor 130 may be configured to determine a similarity or a consistency of the signals through a mutual comparison of the binary signals.

For example, as illustrated in FIG. 7, the processor 130 may compare the patterns by performing a simple AND operation on the compensated brake light activation signal 702 of the preceding vehicle or the surrounding vehicle and the brake light activation signal 703 of the autonomous vehicle.

In FIG. 7, as a result of performing an AND operation on the compensated brake light blinking pattern 702 of the preceding vehicle or the surrounding vehicle and the brake light blinking pattern 703 of the autonomous vehicle 10, since 6 values out of a total of 7 binary signals match (1+1+1+1+1+0+1=6) as in area 704, the consistency of the activation signal may be determined as about 85.71% (=6/7×100%).

When the consistency determined as above is less than a preset threshold (e.g., 70%), the processor 130 may be configured for controlling the driving by determining that the braking signal of the preceding vehicle or the surrounding vehicle is abnormal or that an unexpected situation has occurred.

Meanwhile, the blinking patterns in FIG. 7 may be a result of a comparison of brake light activation signals of at least two of the preceding vehicle, the surrounding vehicles, or the autonomous vehicle 10. For example, the pattern 701 may be the activation pattern of the preceding vehicle and the pattern 702 may be the compensated pattern thereof, and the pattern 703 may be the activation pattern of the surrounding vehicles or the activation pattern of the autonomous vehicle 10.

The processor 130 may, through the compensated comparison and analysis result, determine the preceding vehicle to be an abnormally driving vehicle when a braking pattern of the preceding vehicle deviates from a normal range as compared to the surrounding vehicles (S325).

In detail, when a braking frequency or a duration of an activation signal of the preceding vehicle deviates from an average value of the surrounding vehicles by a predetermined reference value or more, the processor 130 may be configured to determine the driving of the preceding vehicle to be abnormal.

When the preceding vehicle is determined to be an abnormal vehicle in step S325, the processor 130 may reduce the speed of the autonomous vehicle 10, increase the safety distance from the preceding vehicle, or perform an avoidance control such as overtaking (S330).

Next, the processor 130 may be configured to determine whether an unexpected situation has occurred by determining whether a change in the brake light signal occurs rapidly and is greater than or equal to a threshold within a predetermined time period (S335).

For example, the processor 130 may be configured to determine an unexpected situation when the brake light of the preceding vehicle blinks rapidly three or more times within one second, or is continuously activated for two seconds or more when activated once.

When the unexpected situation occurs, the processor 130 may emergently decelerate the vehicle or perform an emergency lane change (S340).

According to an exemplary embodiment of the present disclosure, when it is determined that a preceding vehicle is an abnormal vehicle because its braking pattern deviates from a normal range as a result of a comparison and analysis with surrounding vehicles (S325: Yes), the processor 130 may perform a first driving control (S330), and when it is determined that an unexpected situation has occurred due to a rapid change in the brake light activation signal from the preceding vehicle (S335: Yes), the processor 130 may perform a second driving control (S340).

The first driving control (S330) may be a control method that is performed when it is determined that the driving of the preceding vehicle is unstable or abnormal. For example, the processor 130 may be configured for controlling the driving unit 160 to preemptively increase the safety distance from the preceding vehicle, minimize interference with the abnormally driving vehicle through a proactive lane change to a surrounding lane, or overtake the corresponding vehicle. That is, the first driving control is a control performed in a relatively less urgent situation to prepare in advance for a foreseeable risk.

On the other hand, the second driving control (S340) may be a control method performed for the purpose of an immediate response when an unexpected situation occurs due to a sudden braking of the preceding vehicle. For example, the processor 130 may be configured for controlling the driving unit 160 to perform an immediate deceleration by activating an emergency brake, or to perform an emergency avoidance maneuver into a surrounding lane. That is, the second driving control is a control that performs an urgent and immediate response to a suddenly occurring dangerous situation.

The first driving control (S330) as described above is a proactive response control for a potential risk caused by an abnormal vehicle, and the second driving control (S340) may be an emergency response control method for a sudden, unexpected dangerous situation.

When it is determined that a braking pattern of the preceding vehicle is irregular and thus not suitable for following, the processor 130 may stop following the preceding vehicle or perform a lane change (S345).

According to an additional embodiment, the processor 130 may be configured for controlling driving of the autonomous vehicle 10 by considering, in addition to the compensated brake light activation signal, road condition information from real-time map information.

The processor 130 may additionally obtain information such as traffic congestion information, road construction information, and accident information from real-time map information received from an external server or stored in advance in the storage unit 120, and may be configured to determine whether braking signals of the preceding vehicle and the surrounding vehicles have consistency with the road environment.

For example, even if the brake light activation signal of the preceding vehicle is different from that of the surrounding vehicles, the processor 130 may, when road construction or traffic congestion is confirmed on the real-time map information, consider this to analyze whether the corresponding situation is an abnormal situation or is caused by a normal traffic situation.

After comparing and evaluating a driving pattern of the autonomous vehicle with a driving pattern of surrounding vehicles, the processor 130 may provide the result to a user visually or audibly via the input/output interface 140 (S350).

When a braking frequency of a driver is remarkably high compared to that of surrounding vehicles, the processor 130 may output a message to the driver related to improving driving habits.

Referring to FIG. 6, a brake light activation pattern of the autonomous vehicle 10 may be mutually compared with a brake light activation pattern of the preceding vehicle 20 and surrounding vehicles 30a and 30c. According to an exemplary embodiment of the present disclosure, the processor 130 may be configured to determine the driving pattern of the autonomous vehicle 10 by comparing and analyzing a frequency or a duration of brake light activation of the autonomous vehicle 10 and a frequency or a duration of brake light activation of the surrounding vehicles 30 and the preceding vehicle 20.

When a braking frequency or duration of the autonomous vehicle 10 is higher than an average value of the surrounding vehicles 30 or is irregular, the processor 130 may suggest to a driver a reduction in braking frequency and smoother acceleration and deceleration, or may perform more efficient and safer driving by changing a control method of the autonomous vehicle.

Meanwhile, various embodiments of the present disclosure disclosed with reference to FIGS. 2, 3, 4, 5, 6, and 7 may be performed under a specific condition. The specific condition may be, for example, a state in which image recognition for a vehicle or reliability of a sensor is low due to poor weather conditions.

For example, the processor 130 may be configured to determine that an image recognition accuracy and a sensor reliability for a target vehicle by the sensor unit of the autonomous vehicle 10 may be lowered in an adverse weather environment such as low light (night), fog, rain, or heavy snow.

In detail, when an object recognition probability output by a front camera of the vehicle is lowered to be less than or equal to a predetermined threshold, or when a resolution or a contrast value of a vehicle image is less than or equal to a predetermined reference, the processor 130 may be configured for controlling driving of the autonomous vehicle by comparing brake light activation signals according to the operations of FIGS. 2 and 3.

However, the present disclosure is not limited to an exemplary embodiment that is activated under the specific condition as described above, and various exemplary embodiments of the present disclosure may of course also be performed as a default setting in the autonomous vehicle 10.

The term 'unit' as used in the exemplary embodiment of the present disclosure refers to a software or hardware component such as a field-programmable gate array (FPGA) or an Application-Specific Integrated Circuit (ASIC), and the 'unit' performs certain roles. However, the 'unit' is not limited in meaning to software or hardware. A 'unit' may be configured to be in an addressable storage medium and may be configured to execute at least one processor.

Accordingly, as an exemplary embodiment of the present disclosure, a 'unit' includes components such as software components, object-oriented software components, class components, and task components, and processes, functions, attributes, procedures, subroutines, segments of program code, drivers, firmware, microcode, circuitry, data, databases, data structures, tables, arrays, and variables. The functionality disposed in the components and 'units' may be combined into a smaller number of components and 'units' or further separated into additional components and 'units'. Furthermore, the components and 'units' may be implemented to execute one or more CPUs within a device or a secure multimedia card.

Although the preferable embodiments of the present disclosure have been described above, it will be understood by those of ordinary skill in the art that various modifications and changes may be made to the present disclosure without departing from the spirit and scope of the present disclosure as defined in the following claims.

What is claimed is:

1. A control device for a host vehicle, the control device comprising:
a memory; and
at least one processor operatively connected to the memory, wherein the at least one processor:
obtains, via a sensor unit operatively connected to the at least one processor, a brake light activation signal of a preceding vehicle and a brake light activation signal of one or more surrounding vehicles;
controls driving of the host vehicle by comparing the brake light activation signal of the preceding vehicle with the brake light activation signal of the one or more surrounding vehicles.

2. The control device of claim 1, wherein the at least one processor compares the brake light activation signal of the preceding vehicle with the brake light activation signal of the one or more surrounding vehicles by compensating for a time delay,
wherein the time delay is based on relative positions and inter-vehicle distances among the preceding vehicle, the one or more surrounding vehicles, and the host vehicle.

3. The control device of claim 1, wherein the at least one processor controls the driving of the host vehicle further based on road condition information.

4. The control device of claim 1, wherein the at least one processor:
converts brake light activation signals of at least two of the preceding vehicle, the one or more surrounding vehicles, or the host vehicle into binary signals; and
controls the driving of the host vehicle by comparing the converted binary signals with each other.

5. The control device of claim 1,
wherein, in response to the comparing indicating that a consistency between the brake light activation signal of the preceding vehicle and the brake light activation signal of the one or more surrounding vehicles is less than or equal to a predetermined threshold, the at least one processor controls the driving of the host vehicle to:
increase a safety distance, which is a distance required for stable deceleration or avoidance of the host vehicle, from the preceding vehicle; or
overtake or avoid the preceding vehicle.

6. The control device of claim 1, wherein, in response to the brake light activation signal of the preceding vehicle changing by an amount greater than or equal to a reference threshold, the at least one processor controls the driving of the host vehicle to:
decelerate the host vehicle;
increase an inter-vehicle distance of the host vehicle with the preceding vehicle; or
avoid the preceding vehicle.

7. The control device of claim 1, wherein the at least one processor:
compares the brake light activation signal of the preceding vehicle and the brake light activation signal of the one or more surrounding vehicles with a brake light activation signal of the host vehicle to determine a driving pattern of the host vehicle; and
provides a result of the determining to a user via an input/output interface of the host vehicle.

8. The control device of claim 1, wherein brake lights of the preceding vehicle and the one or more surrounding vehicles, from which the brake light activation signals are obtained, include at least one of:
a brake light of a first brake lamp disposed on a rear side of the preceding vehicle and the one or more surrounding vehicles; or
a brake light of a second brake lamp located at a different location on the rear side of the preceding vehicle and the one or more surrounding vehicles.

9. The control device of claim 1, wherein the at least one processor:
determines whether to follow the preceding vehicle based on the comparing of the brake light activation signal of the preceding vehicle and the brake light activation signal of the one or more surrounding vehicles; and
controls the driving of the host vehicle to follow or not to follow the preceding vehicle based on a result of the determining.

10. The control device of claim 1, wherein the at least one processor controls the driving of the host vehicle by comparing the brake light activation signal of the preceding vehicle and the brake light activation signal of the one or more surrounding vehicles, based on that an image recognition accuracy obtained via the sensor unit or an object recognition reliability of the sensor unit is less than or equal to a predetermined threshold.

11. A method for controlling a host vehicle, the method comprising:
obtaining, by at least one processor via a sensor unit of the host vehicle, a brake light activation signal of a preceding vehicle and a brake light activation signal of one or more surrounding vehicles;
comparing, by the at least one processor, the brake light activation signal of the preceding vehicle with the brake light activation signal of the one or more surrounding vehicles; and
controlling, by the at least one processor, driving of the host vehicle based on a result of the comparing.

12. The method of claim 11, wherein the comparing comprises compensating for a time delay based on relative positions and inter-vehicle distances among the preceding vehicle, the one or more surrounding vehicles, and the host vehicle.

13. The method of claim 11, wherein the controlling is further based on road condition information.

14. The method of claim 11, further comprising:
converting, by the at least one processor, brake light activation signals of at least two of the preceding vehicle, the one or more surrounding vehicles, or the host vehicle into binary signals; and
wherein the comparing comprises mutually comparing the converted binary signals.

15. The method of claim 11, wherein the controlling comprises, in response to the comparing indicating that a consistency between the brake light activation signal of the preceding vehicle and the brake light activation signal of the one or more surrounding vehicles is less than or equal to a predetermined threshold:
increasing a safety distance, which is a distance required for stable deceleration or avoidance of the host vehicle, from the preceding vehicle; or
overtaking or avoiding the preceding vehicle.

16. The method of claim 11, wherein the controlling comprises, in response to the brake light activation signal of the preceding vehicle changing by an amount greater than or equal to a reference threshold:
decelerating the host vehicle;
increasing an inter-vehicle distance of the host vehicle with the preceding vehicle; or
avoiding the preceding vehicle.

17. The method of claim 11, further comprising:
comparing, by the at least one processor, the brake light activation signal of the preceding vehicle and the brake light activation signal of the one or more surrounding vehicles with a brake light activation signal of the host vehicle to determine a driving pattern of the host vehicle; and
providing, by the at least one processor, a result of the determining to a user via an input/output interface of the host vehicle.

18. The method of claim 11,
wherein the brake light activation signals are obtained from brake lights of the preceding vehicle and the one or more surrounding vehicles, and
wherein the brake lights comprise at least one of:
a brake light of a first brake lamp disposed on a rear side of the preceding vehicle and the one or more surrounding vehicles; or
a brake light of a second brake lamp located at a different location on the rear side of the preceding vehicle and the one or more surrounding vehicles.

19. The method of claim 11, further comprising:
determining, by the at least one processor, whether to follow the preceding vehicle based on the comparing; and
controlling the driving of the host vehicle to follow or not to follow the preceding vehicle based on a result of the determining.

20. The method of claim 11, wherein the comparing and the controlling are performed based on that an image recognition accuracy obtained via the sensor unit or an object recognition reliability of the sensor unit is less than or equal to a predetermined threshold.
